(19) United States
(12) Patent Application Publication
(10) Pub. No.: US 2022/0250183 A1
(43) Pub. Date: Aug. 11, 2022

(54) METHODS AND APPARATUS TO TRAIN A ROBOTIC WELDING SYSTEM TO PERFORM WELDING

(71) Applicant: Illinois Tool Works Inc., Glenview, IL (US)

(72) Inventor: Craig Steven Knoener, Appleton, WI (US)

(21) Appl. No.: 17/669,282

(22) Filed: Feb. 10, 2022

Related U.S. Application Data
(60) Provisional application No. 63/147,964, filed on Feb. 10, 2021.

(51) Int. Cl. B23K 9/095; B25J 11/00; B25J 13/08; B25J 9/16; B25J 19/02

(52) U.S. Cl. CPC B23K 9/0953; B25J 11/005; B25J 19/023; B25J 9/1666; B25J 9/1697; B25J 13/089

(57) ABSTRACT

An example robotic welding system includes: one or more sensors configured to determine a physical position and orientation of a welding tool with respect to a reference frame; and a processor configured to: communicatively connect to a welding-type power supply; during a welding operation performed using the welding tool: track the physical position and orientation of the welding tool within the reference frame; and monitor at least one of an input or an output of the welding-type power supply; and generate a robotic welding procedure based on the tracked physical position and orientation of the welding tool and based on the at least one monitored input or monitored output of the welding-type power supply.

### RELATED APPLICATIONS

The present application claims the benefit of U.S. Patent Application Ser. No. 63/147,964, filed Feb. 10, 2021, entitled “METHODS AND APPARATUS TO TRAIN A ROBOTIC WELDING SYSTEM TO PERFORM WELDING.” The entirety of U.S. Patent Application Ser. No. 63/147,964 is expressly incorporated herein by reference.

### BACKGROUND

This disclosure relates generally to robotic welding and, more particularly, to methods and apparatus to train a robotic welding system to perform welding.

Robotic welding is often used to perform repetitive welding operations involving workpieces having a consistent configuration and series of welds to be performed. However, programming robots to perform the welding can be a difficult, tedious, and error-prone task. As a result, economic factors generally limit conventional robotic welding to high-volume welds or components.

### SUMMARY

Methods and apparatus to train a robotic welding system to perform welding are disclosed, substantially as illustrated by and described in connection with at least one of the figures, as set forth more completely in the claims.

### BRIEF DESCRIPTION OF THE DRAWINGS

FIG. 1 illustrates an example robotic welding system including a training system for training the robotic welding system to perform welding, in accordance with aspects of this disclosure.

FIG. 2 is a block diagram of the example robotic welding system and the example training system of FIG. 1.

FIG. 3 illustrates an example reference frame, generated with reference to a welding table associated with a robot, that may be used by the training system of FIGS. 1 and 2.

FIG. 4 illustrates another example reference frame, generated with reference to a base of the robot, that may be used by the training system of FIGS. 1 and 2.

FIG. 5 illustrates an example implementation of the welding torch of FIG. 2 (e.g., the welding tool of FIGS. 3 and 4) that may be used by the robot training system of FIG. 1 to perform training of the robotic welding system.

FIG. 6 is an example arrangement of markers on a neck of the welding torch of FIG. 6.

FIG. 7 is a top view of another example arrangement of visual markers on the neck of the welding torch of FIG. 5.

FIG. 8 is a block diagram of an example implementation of the welding-type power source of FIGS. 1 and 2.

FIG. 9 is a block diagram of an example computing device that may be used to implement the robot control system, the controller, the computer, the remote computer, and/or the data storage system of FIGS. 1 and/or 2.

FIG. 10 is a flowchart representative of example machine readable instructions which may be executed by the example training device and/or the computing device of FIGS. 1 and 2 to generate a robotic welding procedure based on tracking a physical position and orientation of a welding tool during a welding operation.

The figures are not necessarily to scale. Where appropriate, similar or identical reference numbers are used to refer to similar or identical components.

### DETAILED DESCRIPTION

For the purpose of promoting an understanding of the principles of this disclosure, reference will be now made to the examples illustrated in the drawings and specific language will be used to describe the same. It will nevertheless be understood that no limitation of the scope of the claims is intended by this disclosure. Modifications in the illustrated examples and such further applications of the principles of this disclosure as illustrated therein are contemplated as would typically occur to one skilled in the art to which this disclosure relates.

Disclosed systems and methods significantly improve the speed and reduce the difficulty of programming robotic welding systems to perform welding operations. Instead of manually programming in physical location points, orientations, obstacles, welding parameters, and/or other factors via a user interface, or hand-guiding the robotic welding tool through the welding trajectory while the robotic system collects data, disclosed systems and methods generate a robotic welding procedure by observing a welding tool during a real (e.g., arc-on) or simulated welding procedure performed with the welding tool. In disclosed examples, the welding tool used for training may be a manual welding tool, or otherwise disconnected from a robotic arm.

In some disclosed examples, a human welder may use the welding tool to perform a manual weld while a robotic weld training system observes the positions and orientations of the welding tool and the welding parameters occurring during the manual weld. The robotic weld training system converts the observed position and orientation information, as well as the observed welding parameters, into a robotic welding procedure that can be understood and executed by one or more robotic welding systems to replicate the welding operation used to create the robotic welding procedure.

Compared to conventional robotic welding training techniques, disclosed systems and methods are substantially easier to implement. Disclosed systems and methods may also reduce the barriers to entry for, for example, small and mid-sized fabricators to use robotic welding systems for repeated welds and/or parts in quantities that would not have been economically feasible if the robotic welding systems required programming using conventional techniques.

As used herein, the word “exemplary” means “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

As utilized herein the terms “circuits” and “circuitry” refer to physical electronic components (i.e. hardware) and any software and/or firmware (code) that may configure the hardware, be executed by the hardware, and/or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by an operator-configurable setting, factory trim, etc.).

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

Some disclosed examples describe electric currents being conducted “from” and/or “to” locations in circuits and/or power supplies. Similarly, some disclosed examples describe “providing” electric current via one or more paths, which may include one or more conductive or partially conductive elements. The terms “from,” “to,” and “providing,” as used to describe conduction of electric current, do not necessitate the direction or polarity of the current. Instead, these electric currents may be conducted in either direction or have either polarity for a given circuit, even if an example current polarity or direction is provided or illustrated.

Disclosed example robotic welding systems include: one or more sensors configured to determine a physical position and orientation of a welding tool with respect to a reference frame; and a processor configured to: communicatively connect to a welding-type power supply; during a welding operation performed using the welding tool: track the physical position and orientation of the welding tool within the reference frame; and monitor at least one of an input or an output of the welding-type power supply; and generate a robotic welding procedure based on the tracked physical position and orientation of the welding tool and based on the at least one monitored input or monitored output of the welding-type power supply.

Some example robotic welding systems further include a collaborative robot configured to perform the robotic welding procedure. Some example robotic welding systems further include a welding table, in which the collaborative robot is configured to perform welding on workpieces on the welding table, and the processor is configured to calibrate the reference frame with respect to the welding table. In some example robotic welding systems, the collaborative robot includes a base configured to secure the collaborative robot to a support structure, and the processor is configured to calibrate the reference frame with respect to the base.

In some example robotic welding systems, the base includes a first plurality of markers observable by at least one of the one or more sensors, and the processor is configured to calibrate the reference frame based on the markers. In some example robotic welding systems, the welding tool includes a second plurality of markers observable by at least one of the one or more sensors, and the processor is configured to determine the physical position and orientation of the welding tool based on the second plurality of markers. In some example robotic welding systems, the welding tool includes a third plurality of markers that are visually distinguishable from the second plurality of markers and observable by at least one of the one or more sensors, and the processor is configured to determine the physical position and orientation of the welding tool based on the third plurality of markers.

In some example robotic welding systems, the one or more sensors are configured to determine a physical position and orientation of an obstacle, and the processor is configured to generate the robotic welding procedure to avoid at least one of a motion or a position calculated to cause a collision based on the obstacle. In some example robotic welding systems, the processor is configured to generate the robotic welding procedure by filtering at least one of the physical position or orientation of the welding tool.

Some example robotic welding systems further include a fixture configured to hold a workpiece associated with the robotic welding procedure in a same location during the robotic welding procedure as during the welding operation. In some example robotic welding systems, the processor is configured to track the physical position and orientation of the welding tool by tracking one or more of a travel angle, a work angle, a contact-tip-to-work distance, a travel speed, or an aim.

In some example robotic welding systems, wherein the processor is configured to monitor the input or output of the welding-type power supply by monitoring one or more of: a trigger command, a gas purge command, a jog command, a schedule parameter, a wire speed parameter, a voltage parameter, an arc length parameter, a current parameter, an electrode type parameter, an electrode diameter parameter, a gas type parameter, a material thickness parameter, a process parameter, a pulses per second parameter, an alternating current (AC) control parameter, or an arc control parameter. In some example robotic welding systems, the processor is configured to monitor the inputs or outputs of the welding-type power supply by monitoring one or more of: an output indicator, a current detection indicator, a touch detection indicator, a ready indicator, an error indicator, a voltage feedback variable, a current feedback variable, a wire feed speed setpoint variable, a voltage setpoint variable, a current setpoint variable, or an arc length setpoint variable.

In some example robotic welding systems, the processor is configured to generate the robotic welding procedure by generating commands for joints of a robot. In some example robotic welding systems, the processor is configured to generate the robotic welding procedure by generating at least one of a welding trigger command or a commanded welding-type parameter.

Disclosed example methods to train a robotic welding system involve: configuring, using one or more sensors, a reference frame based on a predetermined component of a robotic welding system; determining, using the one or more sensors, a physical position and orientation of a welding tool with respect to the reference frame; tracking, using the one or more sensors and a processor, the physical position and orientation of the welding tool within the reference frame during a welding operation performed using the welding tool; monitoring, via the processor, at least one of an input or an output of the welding-type power supply; and generating, using the processor, a robotic welding procedure based on the tracked physical position and orientation of the welding tool.

In some example methods, the generating of the robotic welding procedure involves generating commands for joints of a robot. In some example methods, the generating of the robotic welding procedure involves generating at least one of a welding trigger command or a commanded welding-type parameter. In some example methods, the configuring of the reference frame is based on at least one component associated with a collaborative robot configured to perform the robotic welding procedure. Some example methods further involve positioning the one or more sensors adjacent the robotic welding system and moving the one or more sensors away from the robotic welding system following the welding operation.

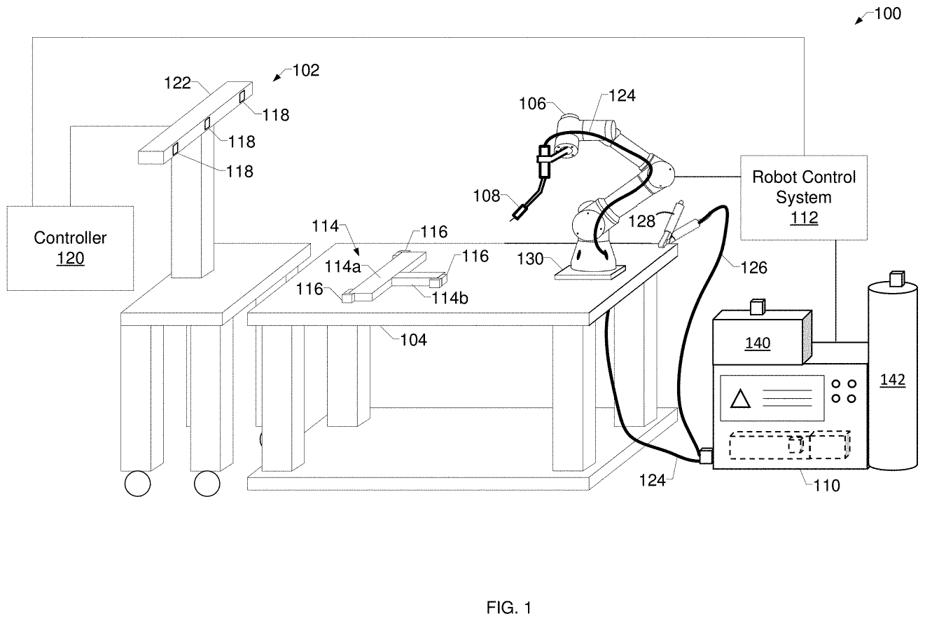

FIG. 1 illustrates an example robotic welding system 100 including a training system 102 for training the robotic welding system 100 to perform welding. The example robotic welding system 100 of FIG. 1 includes a welding table 104, a robotic manipulator 106 configured to manipulate a welding torch 108, a welding-type power supply 110, and a robot control system 112.

The welding table 104, robotic manipulator 106, the welding torch 108, the welding-type power supply 110, and/or the robot control system 112, and/or subgroups of these components, may be packaged together (e.g., pre-assembled, pre-calibrated) to provide rapid setup of the robotic welding system 100 for welding at the end-user location. The robotic welding system 100 may be used to make repetitive welds, to leverage the consistency and repeatability advantages of the robotic manipulator 106. In the example of FIG. 1, the robotic manipulator 106 and/or the robot control system 112 are configured as a collaborative robot, which provides features that make the robotic manipulator 106 more conducive to working in areas in which people are proximate the robotic welding system.

In the example of FIG. 1, a workpiece 114 is positioned on the welding table 104. The workpiece 114 may include multiple components 114a, 114b which are to be welded together at one or more joints. To provide consistency in arrangement of the workpiece components 114a, 114b, the robotic welding system 100 may further include fixtures 116 attached to the welding table 104. The fixtures 116 may guide the placement of the components 114a, 114b, which can be used to consistently place the multiple components 114a, 114b.

While the robotic welding system 100 can weld the same weld consistently and repeatedly, the robotic welding system 100 must be programmed to perform the weld. As mentioned above, conventional techniques for programming the robotic welding system 100 can be cumbersome, time-consuming, and costly, and can limit the types and/or quantities of parts that can be cost-effectively performed by replacing manual welding with the robotic welding system 100. The training system 102 of FIG. 1 is configured to enable quicker, easier programming of the robotic welding system 100 to perform one or more welds on a workpiece 114.

To this end, the example training system 102 includes sensor(s) 118 coupled to a controller 120. The sensor(s) 118 are configured to determine a physical position and orientation of a welding tool, with respect to a reference frame, during a teaching weld operation. Based on the tracked physical position and orientation of the welding tool during the teaching weld operation, the controller 120 generates a robotic welding procedure to enable the robotic welding system 100 to reproduce the teaching weld operation. For example, the controller 120 may generate commands for the joints of the robotic manipulator 106, commands to configure the welding-type power supply 110, trigger commands, and/or any other commands that may be used to configure and/or control a robotic welding operation.

As disclosed in more detail below, the welding tool may be a manual welding torch that is manipulated by a weld operator, and the reference frame may be defined for the training system 102 to establish position and/or orientation information in a manner that can later be used by the robotic welding system 100 to perform welding. The controller 120 is in communication with the sensor(s) 118, and tracks the physical position and orientation of the welding tool within the reference frame during a welding operation performed using the welding tool.

The example sensor(s) 118 of FIG. 1 are optical sensor(s) (e.g., cameras) attached to a frame 122 to orient the respective fields of view of the sensor(s) 118 toward the reference frame. As disclosed in more detail below, the reference frame may be established based on one or more locations which are fixed with respect to the robotic manipulator 106, to enable translation of the locations and/or orientation identified by the sensors 118 and the controller 120 to commands to the robotic manipulator 106. For example, a base of the robotic manipulator 106 may be used as a fixed location from which to establish the reference frame.

During the welding procedure generated by the training system 102, the robotic welding system 100 manipulates the welding torch 108, such as the illustrated welding torch, to which power is delivered by the welding-type power supply 110 via a first conductor 124 and returned by way of a work cable 126 and a work clamp 128 coupled to the work table 104. The welding equipment may further include, for example, a source of shielding gas 142, a wire feeder 140, and other accessories and/or equipment. Other accessories and/or equipment may include, for example, water coolers, fume extraction devices, one or more controllers, sensors, user interfaces, and/or communication devices (wired and/or wireless).

The example robotic welding system 100 is configured to form a weld using any known electric welding techniques. Example electric welding techniques include shielded metal arc welding (SMAW), MIG, flux-cored arc welding (FCAW), TIG, laser welding, sub-arc welding (SAW), stud welding, friction stir welding, and resistance welding.

The example robotic manipulator 106 may operate using any number of degrees of freedom to manipulate the welding torch 108. For example, the robotic manipulator 106 may include multiple joints, in which each joint has one or more degrees of freedom, to achieve multiple orientations for accessing one or more weld joints on the workpiece 114. Whereas conventional welding robots are contained within a weld cell that is protected against intrusion by operators during robot operations (e.g., welding operations and/or other movement by the robot), in some examples the robotic welding system 100 is configured as a cobot, has a controller or processor, as well as one or more sensors, that are configured to operate in a manner such that humans do not necessarily need to be excluded from the area in which the robotic manipulator 106 is operating. For example, the robotic manipulator 106 may rapidly detect and respond to collisions, may operate with reduced speed and/or joint torque relative to conventional welding robots, and/or implement other features.

The robotic manipulator 106 is coupled to the table 104 via a base 130. Once secured, the base 130 is fixed with respect to the table 104, and may serve as a reference for position and/or orientation for the robotic manipulator 106.

The example controller 120, robotic manipulator 106, and/or robot control system 112 are configured to transmit commands, requests, data, and/or other messages and/or communications to the power supply 110 via one or more protocols. The controller 120, robotic manipulator 106, and/or the robot control system 112 are further configured to receive responses, acknowledgments, data, and/or other messages and/or communications from the power supply 110 via the one or more protocols. For example, the controller 120 may communicate parameters to the power supply 110 while configuring the welding process for teaching the robotic welding system 100, and/or receive data from the welding process for use in generating the robotic welding procedure. Based on the robotic welding procedure, the robotic manipulator 106 and/or the robot control system 112 may communicate parameters to the power supply 110 for configuration according to the robotic welding procedure, and/or adjust the welding-type process based on the variables and/or other data obtained from the power supply 110 while performing welding operations. In addition to communication between the power supply 110 and the controller 120, the robotic manipulator 106, and/or the robot control system 112, the power supply 110, the controller 120, the robotic manipulator 106, and/or the robot control system 112 may communicate with other welding equipment (e.g., a welding accessory, such as the wire feeder 140) and/or other robotic equipment.

Example power source input parameters that may be transmitted by the controller 120, the robotic manipulator 106, and/or the robot control system 112 to the power supply 110 (e.g., directly, via a network, via a communications bus, etc.) include: a trigger command (e.g., to command the power supply 110 whether to output welding-type power and, when a wire-fed process is used, to command the power supply 110 or a separate wire feeder to feed wire); a purge command (e.g., to command the power supply 110 whether to output shielding gas); a jog command (e.g., to command the power supply 110 or a separate wire feeder whether to feed wire without outputting welding-type power); a schedule parameter (e.g., to select one of one or more previously defined sets of welding parameters); a wire speed parameter (e.g., to cause the power supply 110 or a wire feeder to control wire feeding to a specified rate); a voltage parameter (e.g., to cause the power supply 110 to output the welding-type power using a specified target voltage); an arc length parameter (e.g., to cause the power supply 110 to output the welding-type power based on a specified arc length); a current parameter (e.g., to cause the power supply 110 to output the welding-type power based on a specified target current); an electrode type parameter (e.g., to cause the power supply 110 to configure one or more welding parameters based on a specified electrode type); an electrode diameter parameter (e.g., to cause the power supply 110 to configure one or more welding parameters based on a specified electrode diameter); a gas type parameter (e.g., to cause the power supply 110 to configure one or more welding parameters based on a specified gas type); a material thickness parameter (e.g., to cause the power supply 110 to configure one or more welding parameters based on a specified material thickness of a workpiece); a process parameter (e.g., to cause the power supply 110 to output the welding-type power based on a specified welding-type process, such as pulse, short arc MIG, TIG, stick, etc.); a pulses per second parameter (e.g., to cause the power supply 110 to output the welding-type power based on a specified number of pulses per second in a pulse process); an alternating current (AC) control parameter (e.g., an AC frequency, an AC balance, an AC wave shape, etc.); and/or an arc control parameter (e.g., to cause the power supply 110 to output the welding-type power based on a specified arc control, or simulated inductance, parameter).

Example power source output parameters that may be transmitted by the power supply 110 to the controller 120, the robotic manipulator 106, and/or the robot control system 112 (e.g., directly, via a network, via a communications bus, etc., asymmetrically and/or in response to a request) include: an output indicator (e.g., an indication of whether the power supply 110 is currently outputting welding-type current, an indication of whether the power supply 110 has an active welding-type output, etc.); a current detection indicator (e.g., an indication of whether a current output is currently detected by the power supply 110); a touch detection indicator (e.g., an indication of whether a short circuit is currently measured or detected by the power supply 110); a gas on indicator (e.g., an indication of whether the power supply 110 is currently outputting shielding gas and/or controlling a gas valve to output shielding gas); a ready indicator (e.g., an indication of whether the power supply 110 is in a state in which a welding-type operation could be performed, an indication of whether the power supply 110 is in an error or other state in which a welding-type operation could not be performed, an indication of whether the power supply 110 will respond to a trigger command, etc.); an error indicator (e.g., an indication of whether the power supply 110 is in an error state); a voltage feedback variable (e.g., a measured voltage feedback currently output by the power supply 110, such as the measured instantaneous voltage, the measured average voltage, the measured RMS voltage, etc.); a current feedback variable (e.g., a measured current feedback currently output by the power supply 110, such as the measured instantaneous current, the measured average current, the measured RMS current, etc.); a wire feed speed setpoint variable (e.g., a wire feed speed setpoint with which the power supply 110 or other wire feeder is currently configured); a voltage setpoint variable (e.g., a welding-type voltage setpoint with which the power supply 110 is currently configured, a control loop target voltage, etc.); a current setpoint variable (e.g., a welding-type current setpoint with which the power supply 110 is currently configured, a control loop target current, etc.); and/or an arc length setpoint variable (e.g., an arc length setpoint with which the power supply 110 is currently configured, a control loop arc length target, etc.).

In some examples, the robot training system 102 may be implemented using components repurposed from a weld training system, such as the LiveArc™ weld training system sold by Miller Electric Mfg. LLC, of Appleton, Wis. In an example of operation, the LiveArc™ weld training system may be positioned adjacent the robotic welding system 100 for a robotic training operation. Following the training operation and generation of a robotic welding procedure, the LiveArc™ weld training system may be moved away from the robotic welding system 100.

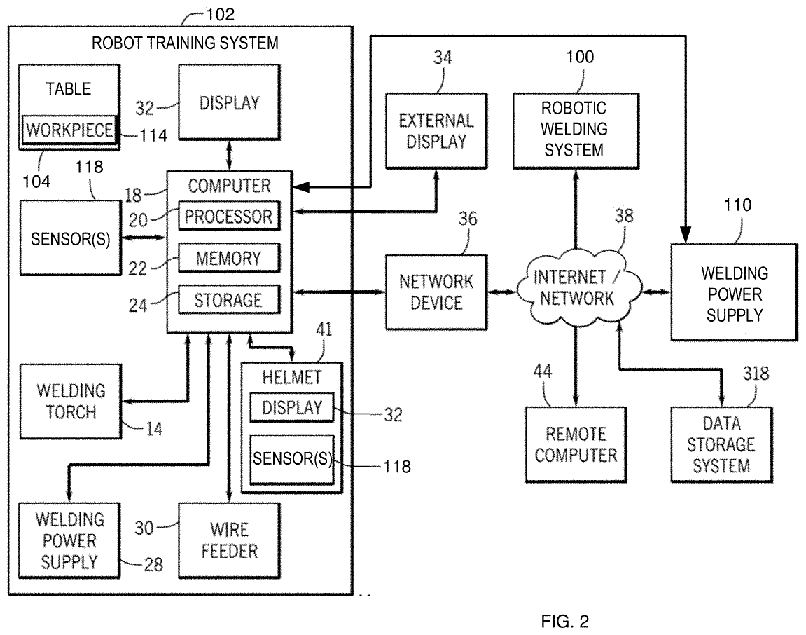

FIG. 2 is a block diagram of the example robotic welding system 100 and the example robot training system 102 of FIG. 1. As used herein, a robotic training system may include any suitable welding related system, including, but not limited to, a welding training system, a live welding system, a remote welding training system (e.g., helmet training system), a simulated welding system, a virtual reality welding system, and/or any other type of live and/or simulated weld training equipment. For example, the robot training system 102 may include, but is not limited to, a LiveArc™ Welding Performance Management System available from Miller Electric Mfg. LLC. The robot training system 102 may incorporate the welding table 104 for providing support for various training devices. For example, the table 104 may be configured to support a welding surface, the workpiece 114, the fixtures 116, one or more training arms, and so forth.

The robot training system 102 may include a separate welding torch 14 (e.g., separate from the torch 108) that may be used by a welding operator to perform welding operations (e.g., robotic training operations). In some examples, the welding torch 14 may include a user interface configured to receive inputs from the welding operator, control circuitry configured to process the inputs, and/or a communication interface configured to communicate the inputs. Furthermore, the welding torch 14 may include one or more display and/or indicators to provide data to the welding operator.

Moreover, the robot training system 102 includes the sensors 118 (e.g., sensors, sensing assembly, etc.) used to sense a position of one or more welding devices and/or to sense an orientation of one or more welding devices. For example, the sensors 118 may be used to sense a position and/or an orientation of the table 104, the welding torch 14, a welding surface, the workpiece 114, the fixtures 116, the base 130 of the robotic manipulator 106, one or more training arms, the operator, an identification token, and/or any other objects. The sensors 118 may include any suitable sensing device, such as an inertial sensing device, a motion tracking device, one or more cameras or other optical sensors (e.g., infrared cameras, visible spectrum cameras, high dynamic range (HDR) cameras, etc.), depth sensors, and/or any other type or combination of types of position tracking devices and/or techniques.

The sensors 118 may be positioned in multiple locations about the welding environment of the robotic welding system 100 and/or the robot training system 102, thereby enabling some sensors 118 to monitor the welding environment (e.g., track movement of an object) when other sensors 118 are obscured. For example, a sensor 118 (e.g., camera, depth sensor) integrated with a welding helmet 41 may facilitate tracking the position, orientation, and/or movement of the welding torch 14 relative to a reference frame when the welding torch 14 is at least partially obscured from other sensors 118 by the workpiece 114, the operator, and/or by any other object. For example, markers disposed on the welding torch 14 that facilitate tracking the welding torch 14 may be partially obscured from a first sensor 118, yet be observable by another sensor 118 of the helmet 41. Furthermore, a sensor 118 (e.g., an accelerometer, a gyroscope, an inertial measurement unit (IMU), an electromagnetic emitter, an electromagnetic receiver, an ultrasonic emitter, an ultrasonic receiver etc.) integrated with the welding torch 14 may facilitate tracking the position, orientation, and/or movement of the welding torch 14 relative to the reference frame when the welding torch 14 is at least partially obscured from other sensors 118 (e.g., cameras, depth sensors) by the workpiece 114, the operator, and/or by any other object.

In some examples, the robot training system 102 includes a helmet 41 having a display 32 and one or more sensing devices 118, such as optical or acoustic sensing devices. The example helmet 41 is communicatively coupled to the computer 18, and the helmet 41 may facilitate welding operations to generate robotic welding procedures, and/or welding monitoring on the table 104. In some examples, one or more of the sensors 118 are integrated with the helmet 41 to monitor the position and/or orientation of the welding torch 14 with or without additional sensor(s) 118 external to the helmet 41.

The sensors 118 are communicatively coupled to a computing device (e.g., a computer 18). The sensors 118 are configured to provide data (e.g., image data, acoustic data, sensed data, six degrees of freedom (6DOF) data, etc.) to the computer 18. Furthermore, the sensors 118 may be calibrated and/or otherwise configured by the computer 18. The computer 18 includes one or more processor(s) 20, memory devices 22, and machine readable storage devices 24. The computer 18 may include, but is not limited to, a desktop, a laptop, a tablet computer, a mobile device, a wearable computer, an integrated processing device, and/or any other type of computing device. The processor(s) 20 may be used to execute software, such as welding software, image processing software, sensing device software, and so forth. Moreover, the processor(s) 20 may include one or more microprocessors, such as one or more “general-purpose” microprocessors, one or more special-purpose microprocessors, application specific integrated circuits (ASICS), digital signal processors (DSPs), field programmable gate arrays (FPGAs), and/or any other combination of hardware, firmware, and/or software. For example, the processor(s) 20 may include one or more reduced instruction set (RISC) processors.

The storage device(s) 24 (e.g., nonvolatile storage) may include ROM, flash memory, a hard drive, or any other suitable optical, magnetic, or solid-state storage medium, or a combination thereof. The storage device(s) 24 may store data (e.g., data corresponding to a welding operation, video and/or parameter data corresponding to a welding operation, data corresponding to an identity and/or a registration number of the operator, data corresponding to past operator performance, etc.), instructions (e.g., software or firmware for the welding system, the sensor(s) 118, etc.), and any other suitable data. As will be appreciated, data that corresponds to a welding operation may include a video recording of the welding operation, a simulated video, an orientation of the welding torch 14, a position of the welding torch 14, a work angle, a travel angle, a distance between a contact tip of the welding torch 14 and a workpiece, a travel speed, an aim, a voltage, a current, a traversed path, a discontinuity analysis, welding device settings, and so forth.

The memory device(s) 22 may include a volatile memory, such as random access memory (RAM), and/or a nonvolatile memory, such as read-only memory (ROM). The memory device(s) 22 may store a variety of information and may be used for various purposes. For example, the memory device(s) 22 may store processor-executable instructions (e.g., firmware or software) for the processor(s) 20 to execute, such as instructions for a welding training simulation, for the sensor(s) 118.

In addition, a variety of control techniques for different welding processes, along with associated settings and parameters, may be stored in the storage device(s) 24 and/or memory device(s) 22, along with code configured to provide a specific output (e.g., initiate wire feed, enable gas flow, capture welding current data, detect short circuit parameters, determine amount of spatter, etc.) and/or executed by the processor(s) 20 during operation.

The robot training system 102 may be configured to communicate with, control, and/or receive feedback from the welding-type power supply 110, wire feeder 140, and/or other welding equipment used by the robotic welding system 100. In some examples, the computer 18 may be directly coupled (with or without a communications adapter) to the welding power supply 110 via a communication cable, such as Universal Serial Bus (USB) cable, a standard welding communication cable, and/or any other direct connection). In other examples, the computer 18 may be communicatively coupled to the welding power supply 110 via a network device 36 and a communications network 38.

Additionally or alternatively, the robot training system 102 may include a separate welding power supply 28 to provide welding power to a live-arc welding operation, a separate wire feeder 30 to provide welding wire to the live-arc welding operation, and/or other welding equipment to implement a welding operation for training the robotic welding system 100.

The example robot training system 102 includes a display 32 for displaying data and/or screens associated with welding (e.g., to display data corresponding to a welding software). For example, the display 32 may provide a graphical user interface to a welding operator (e.g., welding engineer, weld operator training the robotic welding system 100, etc.). The graphical user interface may provide various screens to enable the welding operator to set welding parameters, calibrate the sensor(s) 118, configure aspects of the robotic welding procedure to be generated, review the results of a welding operation to be considered for generating the robotic welding procedure, and/or otherwise configure the robotic training operation. The example display 32 may be a touch screen display configured to receive touch inputs or a non-touch screen display.

In some examples, the robot training system 102 is coupled to one or more external displays 34 to enable an individual located remotely from the robot training system 102 to view data corresponding to the robotic training operation.

The robot training system 102 may include or be coupled to the network device 36 to enable the computer 18 to communicate with other devices connected to the Internet or another network 38 (e.g., for providing test results to another device and/or for receiving test results from another device). For example, the network device 36 may enable the computer 18 to communicate with the welding-type power supply 110, the robotic welding system 100, one or more remote computers 44, and/or a data storage system 318 (e.g., a cloud storage system). As may be appreciated, the robot training system 102 disclosed herein may be used to generate robotic welding procedures in a cost-effective manner.

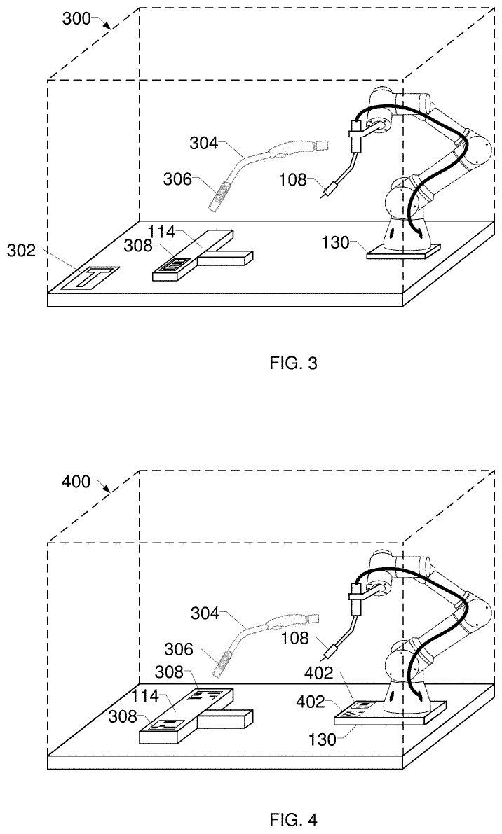

FIG. 3 illustrates an example reference frame 300, generated with reference to the welding table 104 associated with the robotic manipulator 106 of FIG. 1, that may be used by the robot training system 102 of FIGS. 1 and 2. The example reference frame 300 of FIG. 3 may use a 6DOF coordinate system (e.g., X, Y, Z coordinates, and pitch, roll, and yaw angles).

In the example of FIG. 3, the robot training system 102 establishes the reference frame 300 with respect to the welding table 104. To this end, the table 104 includes one or more markers 302 attached to the welding table 104 at predetermined locations. Example markers 302 include two-dimensional codes, printed patterns, patterns of light-emitting diodes (LEDs) or retroreflectors, patterned cutouts on the surface of the table 104, and/or any other type of marker from which the position, scale, and rotation of the marker can be determined by the sensor(s) 118. By identifying the predetermined marker(s) 302 on the table 104 and determining the position, scale, and rotation of the marker(s) 302, the controller 120 determines the position and orientation of the table 104.

From the position and orientation of the table 104, the controller 120 configures the reference frame 300. For example, the controller 120 may select a predetermined point on the table 104 as a reference or origin point for position and orientation information of the workpiece 114, the welding tool 304, the robotic manipulator 106, and the welding torch 108.

A welding tool 304, such as the welding torch 14 of FIG. 2, also includes markers 306 that are visually identifiable via the sensor(s) 118. The markers 306 may be similar or different in type than the marker 302, and allows the controller 120 to determine position, scale, and rotation of the welding tool 304. By determining the position, scale, and rotation of the marker(s) 302 and the marker(s) 306, the controller 120 may determine the positions and orientations of the welding tool 304 within the reference frame 300.

In the example of FIG. 3, the base 130 of the robotic manipulator 106 is at a predetermined, calibrated location and orientation with respect to the table 104. Using the location of the base 130, the controller 120 may generate the robotic welding procedure to mimic the welding operation performed using the welding tool 304 by translating the positions and orientations of the welding tool 304 with respect to the table 104 into positions and orientations of the welding torch 108 with respect to the table 104 and, therefore, with respect to the base 130.

Using the reference frame 300 may involve direct transformations of position and orientation using the relative positions of the markers 302, 306 and the position of the base 130, and/or mapping positions and orientations to a coordinate system.

FIG. 4 illustrates another example reference frame 400, generated with reference to the base 130 associated with the robotic manipulator 106 of FIG. 1, that may be used by the robot training system 102 of FIGS. 1 and 2. In the example of FIG. 4, the base 130 is provided with marker(s) 402, which may be similar or identical to the marker(s) 302 of FIG. 3 on the table 104. The example sensor(s) 118 detect the marker(s) 402, and the controller 120 determines the position, scale, and rotation of the marker(s) 402 to determine the position and orientation of the base 130.

As with the reference frame 300 of FIG. 3, the controller 120 determines the position and orientation of the welding tool 304 and the markers 306 within the reference frame 400. Using the location of the base 130, the controller 120 may generate the robotic welding procedure to mimic the welding operation performed using the welding tool 304 by translating the positions and orientations of the welding tool 304 with respect to the table 104 into positions and orientations of the welding torch 108 with respect to the table 104 and, therefore, with respect to the base 130.

In some examples of FIGS. 3 and/or 4, the workpiece 114 and/or the fixtures 116 may further include marker(s) 308 to enable further mapping of positions and/or orientations of the welding tool 304 to the workpiece 114 and/or the fixtures 116.

In still other examples, the robot training system 102 may define the reference frame with respect to the workpiece 114. For example, one or more markers applied to consistent location(s) on the workpiece 114 may be used to define the reference frame. In such examples, the robotic welding system 100 may include one or more sensor(s) 118 to identify the markers on workpieces 114 on which the robotic welding procedure is performed, to determine the position, scale, and rotation of the workpiece 114 based on the markers, and transform the position and orientation information specified in the robotic welding procedure based on the position and/or orientation of the workpiece 114. For example, the sensor(s) 118 of the robot training system 102 may be substantially permanently affixed to the robotic welding system 100, and/or the robot training system 102 may include different sensor(s) 118 that are configured to identify markers on the workpiece 114 and/or other objects during execution of robotic welding procedures.

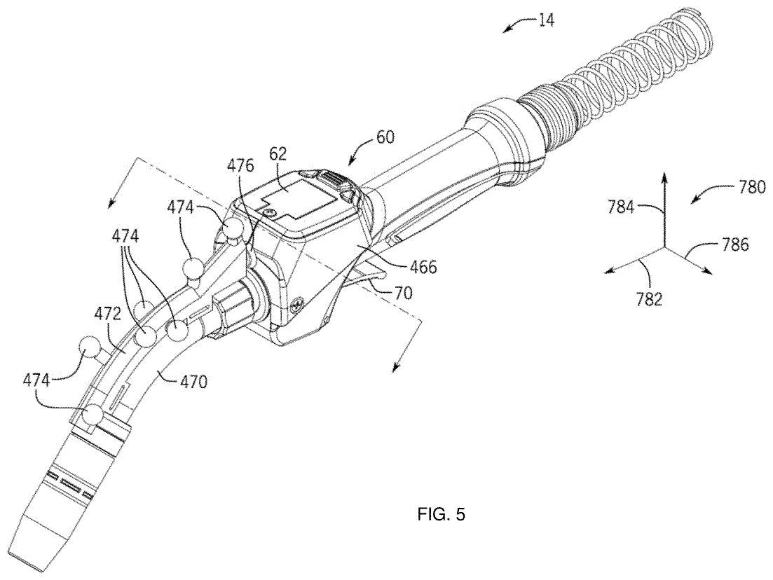

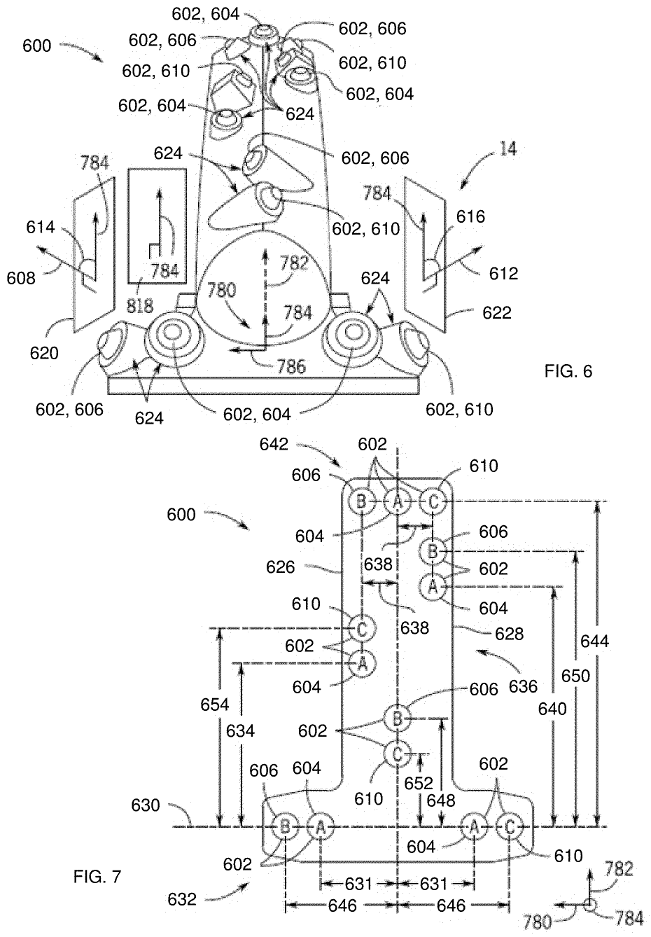

FIG. 5 illustrates an example implementation of the welding torch 14 of FIG. 2 (e.g., the welding tool 304 of FIGS. 3 and 4) that may be used by the robot training system 102 of FIG. 1 to perform training of the robotic welding system 100. The example the welding torch 14 has markers 474 that may be used for tracking the welding torch 14. While FIGS. 5 and 6 illustrate a welding torch 14, other welding devices (e.g., welding tools, stingers, calibration tools) may have markers 474 (e.g., visual markers 602) arranged about the respective welding device in a prescribed pattern that corresponds to a rigid body model of the welding device. Accordingly, from a set of markers 474 detected by the sensor(s) 118, the computer 18 coupled to the sensor(s) 118 may determine the type of welding device, a rigid body model for the welding device, a position of the welding device, and an orientation of the welding device. In some examples, the position of the welding torch 14 may be tracked during the welding operation to determine (i.e., calibrate) the shape of the welding joint. For example, the welding torch 14 may be utilized to trace the shape of a workpiece 82 in various positions including, but not limited, to welding positions 1G, 2G, 3G, 4G, 5G, 6G, 1F, 2F, 3F, 4F, 5F, or 6F. The determined shape of the welding joint may be stored in the data storage system 318 for comparison with a subsequent live welding process along the welding joint. In some examples, the position of the welding torch 14 may be tracked during live welding and compared with the shape of the welding joint stored in the data storage system 318.

In some examples, the welding torch 14 may include sensors (e.g., accelerometers, gyroscopes, etc.) and/or control circuitry to provide approximately real-time feedback to the operator regarding the welding operation. The welding torch 14 includes a housing 466 that encloses the control circuitry of the welding torch 14 and/or any other components of the welding torch 14. In some examples, the welding torch 14 may include a display 62, user interface 60, and/or any other components incorporated into the housing 466 to provide feedback about the welding operation to the operator.

As illustrated, a neck 470 extends from the housing 466 of the welding torch 14. Markers for tracking the welding torch 14 may be disposed on the neck 470. Specifically, a mounting bar 472 is used to couple markers 474 to the neck 470. The example markers 474 of FIG. 5 are spherical markers. In other examples, the markers 474 may be any other shape (e.g., such as a shape of an LED). The sensor(s) 118 monitor the position and orientation of the welding torch 14 by observing and tracking the markers 474. Three of the example markers 474 may be used to define an arbitrary plane. Moreover, the markers 474 are arranged such that a fourth marker 474 is in a second plane different than the first plane. Accordingly, the sensors 118 may be used to track the position and/or the orientation of the welding torch 14 using the four markers 474. It should be noted that while the illustrated example includes four markers 474, the mounting bar 472 may have any suitable number of markers 474.

The markers 474 may be reflective markers (e.g., retroreflectors), light-emitting markers (e.g., LEDs), and/or non-reflective, non-light-emitting markers (e.g., two-dimensional codes, etc.). In examples in which the markers 474 are light-emitting markers, the markers 474 may be powered by electrical components within the housing 466 of the welding torch 14. For example, the markers 474 may be powered by a connection 476 between the mounting bar 472 and the housing 466. Furthermore, the control circuitry of the torch 14 (and/or control circuitry of other equipment) may be used to control powering on and/or off (e.g., illuminating) the markers 474. In some examples, the markers 474 are individually powered on and/or off based on the position and/or the orientation of the welding torch 14. In other examples, the markers 474 are powered on and/or off in groups based on the position and/or the orientation of the welding torch 14. It should be noted that in implementations that do not include the mounting bar 472, the connection 476 may be replaced with another marker 468 on a different plane than the illustrated markers 474.

The welding torch 14 is disclosed herein relative to a consistent set of coordinate axes 780. An X-axis 782 is a horizontal direction along a longitudinal axis of the welding torch 14, a Y-axis 784 is the vertical direction relative to the longitudinal axis, and a Z-axis 786 is a horizontal direction extending laterally from the welding torch 14. In some examples, the controller 120 of the robot training system 102 determines transformations between the reference frame 300, 400 and the coordinate axes 780 corresponding to the torch 14.

FIG. 6 is an example of a neck 600 of the welding torch 14, taken along line 6-6 of FIG. 5. Visual markers 602 are arranged at predefined locations on the neck 600 to facilitate detection of the position and orientation of the welding torch 14 by the sensor(s) 118. In some examples, the visual markers 602 are LEDs. Additionally or alternatively, the visual markers 602 are directional, such that the sensor(s) 118 detect visual markers 602 that are oriented (e.g., centered) toward the sensor(s) 118 (e.g., one or more cameras) more readily than visual markers 602 that are less oriented toward the sensor(s) 118. For example, LEDs arranged on a surface may be directed to emit light (e.g., visible light, infrared light, ultraviolet light) primarily along an axis substantially perpendicular to the surface. Furthermore, one or more of the visual markers 602 may be retroreflectors configured to reflect light substantially toward the direction from which the respective visual marker received the light (e.g., from an infrared light positioned near a camera sensor 118). In some examples, multiple sets of visual markers 602 are arranged on the neck 600.

The visual markers 602 of each set may be oriented (e.g., centered) in substantially the same direction as the other visual markers 602 of the respective set. In some examples, a first set 604 of visual markers 602 is directed substantially vertically along the Y-axis 784, a second set 606 of visual markers 602 is directed in a second direction 608, and a third set 610 of visual markers 602 is directed in a third direction 612. That is, the visual markers 602 of each set are oriented to emit light in substantially parallel directions as other visual markers 602 of the respective set. The second direction 608 is substantially perpendicular to the X-axis 782 along the welding torch 14, and is offset a second angle 614 from the Y-axis 784. The third direction 612 is substantially perpendicular to the X-axis 782 along the welding torch 14, and is offset a third angle 616 from the Y-axis 784. In some examples, the second angle 614 and the third angle 616 have approximately the same magnitude. For example, the second set 606 of visual indicators 602 may be offset from the Y-axis 784 by 45°, and the third set 610 of visual indicators 602 may be offset from the Y-axis 784 by 45°, such that the second angle 614 is substantially perpendicular with the third angle 616. The second angle 614 and the third angle 616 may each be between approximately 5° to 180°, 15° to 135°, 25° to 90°, or 30° to 75°. As may be appreciated, the neck 600 may have 1, 2, 3, 4, 5, 6, 7, 8, 9, 10, or more sets of visual markers 602, with each set oriented in a particular direction to facilitate detection by the sensor(s) 118.

The visual markers 602 of each set may be arranged on the same or substantially parallel planes. For example, the first set 604 of visual markers 602 may be arranged on a first plane 618 or a plane substantially parallel to the first plane 618 that is perpendicular to the Y-axis 784. The second set 606 of visual markers 602 may be arranged on a second plane 620 or a plane substantially parallel to the second plane 620 that is perpendicular to the second direction 608. The third set 610 of visual markers 602 may be arranged on a third plane 622 or a plane substantially parallel to the third plane 622 that is perpendicular to the third direction 612. In some examples, the visual markers 602 of each set may be spatially distributed about the welding torch 14 to maximize the distance between the visual markers 602 of the respective set, which may facilitate determination of the position and orientation of the welding torch 14 relative to the sensing device relative to a more narrow spatial distribution. As used herein, the term “substantially parallel” includes orientations within 10 degrees of parallel, and the term “substantially perpendicular” includes orientations within 10 degrees of perpendicular. The arrangements of the visual markers 602 of each set may facilitate tracking the welding torch 14 during simulated and/or live out-of-position welding processes including, but not limited to, vertical or overhead welding positions.

Structures 624 of the neck 600 may facilitate the orientation of the sets of the visual markers 602. For example, a mounting surface of each structure 624 may be substantially parallel to a respective plane for the corresponding set of visual markers 602. Moreover, the structures 624 may reduce or eliminate the detection of the respective visual marker 602 by the sensor(s) 118 when the respective visual marker 602 is oriented relative to the sensor(s) 118 at an angle greater than a threshold angle. For example, the second set 606 of visual markers 602 may be configured to be detected by the sensor(s) 118 when the operator holds the welding torch 14 with the sensor(s) 118 to the left of the operator (i.e., a left-handed operator), and the third set 610 of visual markers 602 may be configured to be detected by the sensor(s) 118 when the operator holds the welding torch 14 with the sensor(s) 118 to the right of the operator (i.e., a right-handed operator). The neck 600 and/or the structures 624 for the second set 606 of visual markers 602 may reduce or eliminate the detection of the second set 606 of visual markers 602 when a right-handed operator uses the welding torch 14, and vice versa for the third set 610 of visual markers when a left-handed operator uses the welding torch 14.

FIG. 7 is a top view of an arrangement of visual markers 602 on the neck 600 of the welding torch 14, similar to the example of the neck 600 illustrated in FIG. 6. The visual markers 602 of the first set 604 (e.g., “A”), the second set 606 (e.g., “B”), and the third set 610 (e.g., “C”) are arranged at different predefined positions on the neck 600 that enable the sensor(s) 118 to determine which side of the welding torch 14 is most directed towards the sensor(s) 118 via detecting a distinct pattern or arrangement that corresponds to each side (e.g., top, left 626, right 628, bottom, front) of the welding torch 14. Additionally or alternatively, the visual markers 602 (e.g., LEDs) of each set may be respectively colored, thereby enabling the sensor(s) 118 to determine which side of the welding torch 14 is most directed towards the sensor(s) 118 via color detection. That is, the first set 604 may emit light within a first spectrum (e.g., approximately 730 nm infrared), the second set 606 may emit light within a second spectrum (e.g., approximately 650 nm infrared), and the third set 610 may emit light within a third spectrum (e.g., approximately 940 nm). Different wavelengths for each set of visual markers 602 may enable the controller (e.g., computer 18) coupled to the sensor(s) 118 to readily determine which set of visual markers 602 and which side of the welding torch 14 are visible to the sensor(s) 118 based at least in part on which wavelengths are detected.

The sensor(s) 118 may track the position and orientation of the welding torch 14 relative to the table 104, the base 130, and/or the workpiece 114 when the sensor(s) 118 detects a threshold quantity of visual markers 602 of a set. The threshold quantity of visual markers 602 of a set may be at least three, four, five, or more visual markers 602 detectable by the sensor(s) 118 at a time. The threshold quantity of visual markers 602 of a set may be less than or equal to the quantity of visual markers 602 of the respective set. For example, the sensor(s) 118 may detect the right side of the welding torch 14 when detecting the four visual markers 602 of the third set 610, the sensor(s) 118 may detect the top side of the welding torch 14 when detecting the five visual markers 602 of the first set 604, and the sensor(s) 118 may detect the left side of the welding torch when detecting the four visual markers 602 of the second set. In some examples, each set of visual markers 602 have redundant visual markers, such that sensor(s) 118 track the position and the orientation of the welding torch 14 when one or more of the redundant visual markers are obscured from view. The sensor(s) 118 may track the position and the orientation with substantially the same accuracy, regardless of which set is detected by the sensor(s) 118.

The visual markers 602 may be arranged on the neck 600 of the welding torch 14 at positions relative to the X-axis 782 along the welding torch 14, and relative to a baseline 630. For example, the first set 604 may have five visual markers 602: two visual markers 602 along the baseline 630 near a first end 632 of the neck 600 and spaced a first offset 631 from the X-axis 782, a visual marker 602 spaced a first distance 634 from the baseline 630 in a midsection 636 of the neck 600 and spaced a second offset 638 from the X-axis 782 to the left side 626, a visual marker 602 spaced a third distance 640 from the baseline 630 in the midsection 636 and spaced the second offset 638 to the right side 628, and a visual marker 602 near a second end 642 of the neck 600 along the X-axis 782 and spaced a fourth distance 644 from the baseline 630. The second set 606 may have four visual markers 602: a visual marker 602 along the baseline 630 and spaced a third offset 646 from the X-axis 782 on the left side 626, a visual marker 602 spaced a fifth distance 648 from the baseline 630 along the X-axis 782 in the midsection 636, a visual marker 602 spaced a sixth distance 650 from the baseline 630 in the midsection 636 and spaced the second offset 638 from the X-axis 782 on the right side 628, and a visual marker 602 near the second end 642 of the neck 600 spaced the fourth distance 644 from the baseline 630 and spaced the second offset 638 on the left side 626. The third set 610 may have four visual markers 602: a visual marker 602 along the baseline 630 and spaced the third offset 646 from the X-axis 782 on the right side 628, a visual marker 602 spaced a seventh distance 652 from baseline 630 along the X-axis 782 in the midsection 636, a visual marker 602 spaced an eighth distance 654 from the baseline 630 in the midsection 636 and spaced the second offset 638 from the X-axis 782 on the left side 626, and a visual marker 602 near the second end 642 of the neck 600 spaced the fourth distance 644 from the baseline 630 and spaced the second offset 638 on the right side 628.

The arrangements (e.g., distances and offsets relative to the baseline 630 and X-axis 782) of the visual markers 602 for each set 604, 606, 610 may be stored in a memory of the controller 120 (e.g., the memory 22 and/or the storage devices 24 of the computer 18). For example, the arrangements may be stored in a memory as calibrations corresponding to a particular welding tool 304 coupled to the robot training system 102. The robot training system 102 may detect the arrangement of the visual markers 602 directed to the sensor(s) 118, and determine the position and orientation of the welding torch 14 relative to the table 104, the base 130, and/or the workpiece 114 based at least in part on a comparison of the detected arrangement and the arrangements stored in memory. Each set of visual markers 602 may be calibrated, such as prior to an initial use, after reconnecting the welding torch 14, or at a predetermined maintenance interval. To calibrate a set of visual markers 602, the welding torch 14 may be mounted to the table 104 in a predetermined position and orientation such that the respective set of visual markers 602 is substantially directed toward the sensor(s) 118. For example, the first set 604 may be calibrated when the welding torch 14 is mounted such that the Y-axis 784 of the welding torch 14 is generally directed toward the sensor(s) 118, the second set 606 may be calibrated when the welding torch 14 is mounted such that the second direction 608 is generally directed toward the sensor(s) 118, and the third set 610 may be calibrated when the welding torch 14 is mounted such that the third direction 612 is generally directed toward the sensor(s) 118. The operator may verify the calibrations by moving the welding torch 14 about the welding environment relative to the table 104, the base 130, and the sensor(s) 118.

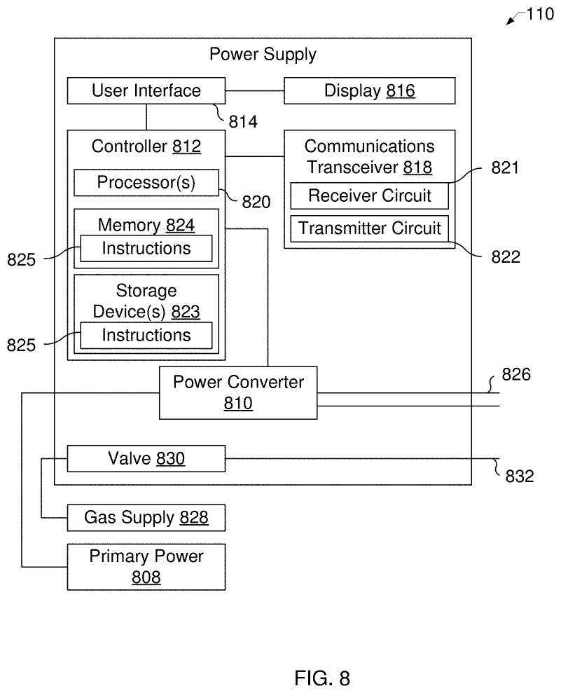

FIG. 8 is a block diagram of an example implementation of the welding-type power supply 110 of FIGS. 1 and 2. The example welding-type power supply 110 powers, controls, and supplies consumables to a welding application. In some examples, the welding-type power supply 110 directly supplies input power to the welding torch 108. In the illustrated example, the welding-type power supply 110 is configured to supply power to welding operations and/or preheating operations. The example welding-type power supply 110 also provides power to a wire feeder to supply electrode wire to the welding torch 108 for various welding applications (e.g., GMAW welding, flux core arc welding (FCAW)).

The welding-type power supply 110 receives primary power 808 (e.g., from the AC power grid, an engine/generator set, a battery, or other energy generating or storage devices, or a combination thereof), conditions the primary power, and provides an output power to one or more welding devices and/or preheating devices in accordance with demands of the system. The primary power 808 may be supplied from an offsite location (e.g., the primary power may originate from the power grid). The welding-type power supply 110 includes a power converter 810, which may include transformers, rectifiers, switches, and so forth, capable of converting the AC input power to AC and/or DC output power as dictated by the demands of the system (e.g., particular welding processes and regimes). The power converter 810 converts input power (e.g., the primary power 808) to welding-type power based on a weld voltage setpoint and outputs the welding-type power via a weld circuit.

In some examples, the power converter 810 is configured to convert the primary power 808 to both welding-type power and auxiliary power outputs. However, in other examples, the power converter 810 is adapted to convert primary power only to a weld power output, and a separate auxiliary converter is provided to convert primary power to auxiliary power. In some other examples, the welding-type power supply 110 receives a converted auxiliary power output directly from a wall outlet. Any suitable power conversion system or mechanism may be employed by the welding-type power supply 110 to generate and supply both weld and auxiliary power.

The welding-type power supply 110 includes a controller 812 to control the operation of the welding-type power supply 110. The welding-type power supply 110 also includes a user interface 814. The controller 812 receives input from the user interface 814, through which a user may choose a process and/or input desired parameters (e.g., voltages, currents, particular pulsed or non-pulsed welding regimes, and so forth). The user interface 814 may receive inputs using any input device, such as via a keypad, keyboard, buttons, touch screen, voice activation system, wireless device, etc. Furthermore, the controller 812 controls operating parameters based on input by the user as well as based on other current operating parameters. Specifically, the user interface 814 may include a display 816 for presenting, showing, or indicating, information to an operator. The controller 812 may also include interface circuitry for communicating data to other devices in the system, such as the wire feeder, the robotic manipulator 106, the robot control system 112, and/or the controller 120. For example, in some situations, welding-type power supply 110 wirelessly communicates with other welding devices within the welding system. Further, in some situations, the welding-type power supply 110 communicates with other welding devices using a wired connection, such as by using a network interface controller (NIC) to communicate data via a network (e.g., ETHERNET, 10baseT, 10base100, etc.).

The controller 812 includes at least one controller or processor 820 (e.g., the processor 20 of FIG. 2) that controls the operations of the welding power supply 110. The controller 812 receives and processes multiple inputs associated with the performance and demands of the system. The processor 820 may include one or more microprocessors, such as one or more “general-purpose” microprocessors, one or more special-purpose microprocessors and/or ASICS, and/or any other type of processing device. For example, the processor 820 may include one or more digital signal processors (DSPs).

The example controller 812 includes one or more storage device(s) 823 (e.g., the storage 24 of FIG. 2) and one or more memory device(s) 824 (e.g., the memory 22 of FIG. 2). The storage device(s) 823 (e.g., nonvolatile storage) may include ROM, flash memory, a hard drive, and/or any other suitable optical, magnetic, and/or solid-state storage medium, and/or a combination thereof. The storage device 823 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, and so forth.

The memory device 824 may include a volatile memory, such as random access memory (RAM), and/or a nonvolatile memory, such as read-only memory (ROM). The memory device 824 and/or the storage device(s) 823 may store a variety of information and may be used for various purposes. For example, the memory device 824 and/or the storage device(s) 823 may store processor executable instructions 825 (e.g., firmware or software) for the processor 820 to execute. In addition, one or more control regimes for various welding processes, along with associated settings and parameters, may be stored in the storage device 823 and/or memory device 824, along with code configured to provide a specific output (e.g., initiate wire feed, enable gas flow, capture welding current data, detect short circuit parameters, determine amount of spatter) during operation.

In some examples, the welding power flows from the power converter 810 through a weld cable 826. The example weld cable 826 is attachable and detachable from weld studs at each of the welding-type power supply 110 (e.g., to enable ease of replacement of the weld cable 826 in case of wear or damage). Furthermore, in some examples, welding data is provided with the weld cable 826 such that welding power and weld data are provided and transmitted together over the weld cable 826.

In some examples, the welding-type power supply 110 includes or is implemented in a wire feeder.

The example communications transceiver 818 includes a receiver circuit 821 and a transmitter circuit 822. Generally, the receiver circuit 821 receives data transmitted by the robotic manipulator 106, the robot control system 112, and/or the controller 120, and the transmitter circuit 822 transmits data to the robotic manipulator 106, the robot control system 112, and/or the controller 120.

In some examples, a gas supply 828 provides shielding gases, such as argon, helium, carbon dioxide, and so forth, depending upon the welding application. The shielding gas flows to a valve 830, which controls the flow of gas, and if desired, may be selected to allow for modulating or regulating the amount of gas supplied to a welding application. The valve 830 may be opened, closed, or otherwise operated by the controller 812 to enable, inhibit, or control gas flow (e.g., shielding gas) through the valve 830. Shielding gas exits the valve 830 and flows through a gas line 832 (which in some implementations may be packaged with the welding power output) to the wire feeder which provides the shielding gas to the welding application. In some examples, the welding-type power supply 110 does not include the gas supply 828, the valve 830, and/or the gas line 832.

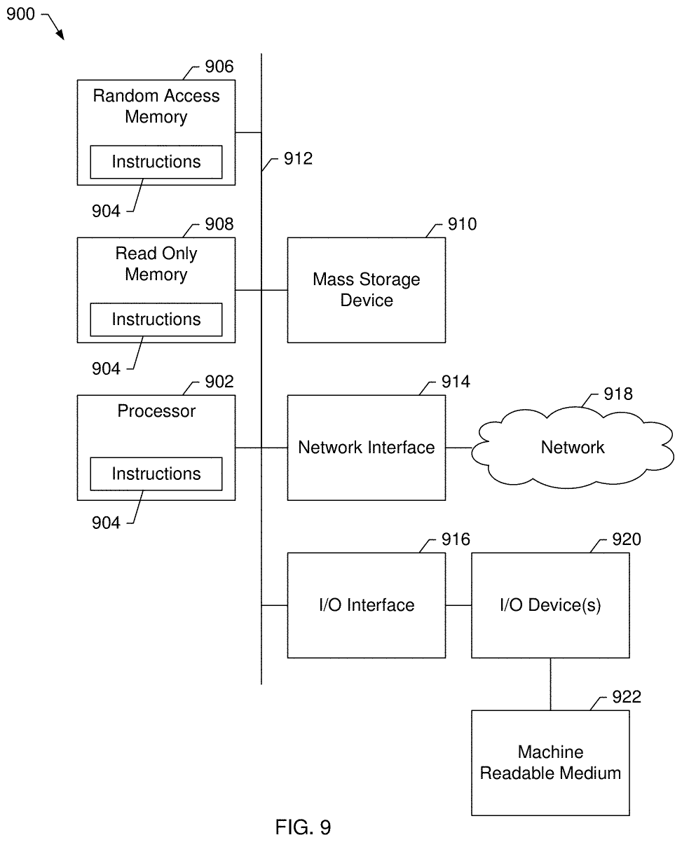

FIG. 9 is a block diagram of an example computing device 900 that may be used to implement the robot control system 112, the controller 120, the computer 18, the remote computer 44, and/or the data storage system 318 of FIGS. 1 and/or 2. The example computing device 900 of FIG. 9 may be a general-purpose computer, a laptop computer, a tablet computer, a mobile device, a server, and/or any other type of computing device. In some examples, the computing device 900 may be implemented in a cloud computing environment using one or more physical machines and, in some examples, one or more virtual machines in the data center.

The example computing device 900 of FIG. 9 includes a processor 902. The example processor 902 may be any general-purpose central processing unit (CPU) from any manufacturer. In some other examples, the processor 902 may include one or more specialized processing units, such as graphic processing units and/or digital signal processors. The processor 902 executes machine readable instructions 904 that may be stored locally at the processor (e.g., in an included cache), in a random access memory 906 (or other volatile memory), in a read only memory 908 (or other non-volatile memory such as FLASH memory), and/or in a mass storage device 910. The example mass storage device 910 may be a hard drive, a solid-state storage drive, a hybrid drive, a RAID array, and/or any other mass data storage device.

A bus 912 enables communications between the processor 902, the RAM 906, the ROM 908, the mass storage device 910, a network interface 914, and/or an input/output interface 916.

The example network interface 914 includes hardware, firmware, and/or software to connect the computing device 900 to a communications network 918 such as the Internet. For example, the network interface 914 may include IEEE 802.X-compliant wireless and/or wired communications hardware for transmitting and/or receiving communications.

The example I/O interface 916 of FIG. 9 includes hardware, firmware, and/or software to connect one or more input/output devices 920 to the processor 902 for providing input to the processor 902 and/or providing output from the processor 902. For example, the I/O interface 916 may include a graphics processing unit for interfacing with a display device, a universal serial bus port for interfacing with one or more USB-compliant devices, a FireWire, a field bus, and/or any other type of interface. Example I/O device(s) 920 may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

The example computing device 900 may access a non-transitory machine readable medium 922 via the I/O interface 916 and/or the I/O device(s) 920. Examples of the machine readable medium 922 of FIG. 9 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

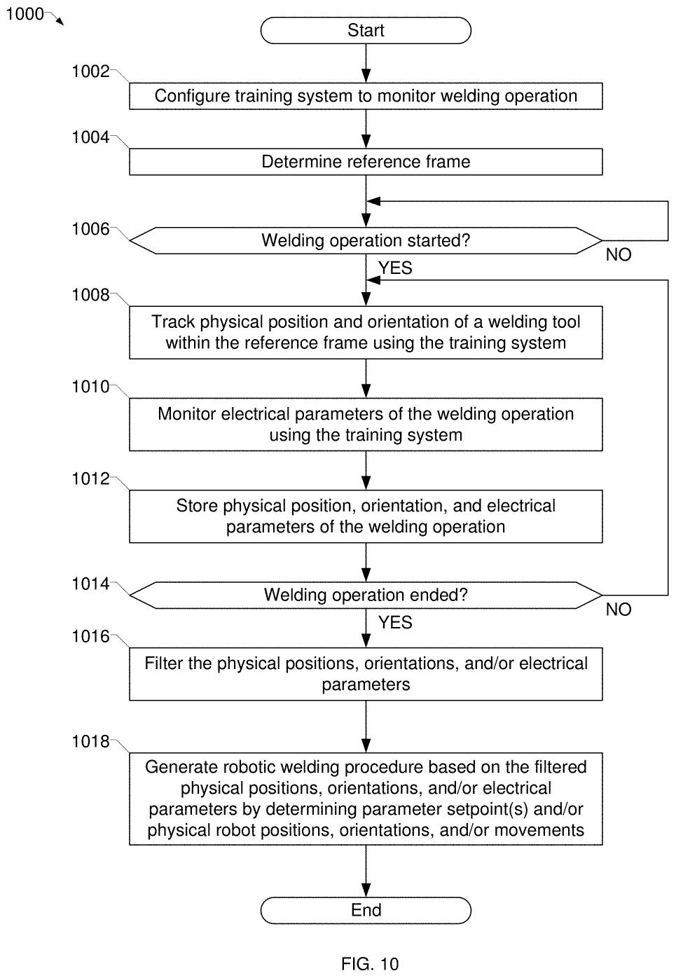

FIG. 10 is a flowchart representative of example machine readable instructions 1000 which may be executed by the example robot training system 102 (e.g., via the computer 18, the processor 20, the computing device 900) of FIGS. 1 and/or 2 to generate a robotic welding procedure. The example instructions 1000 are described with reference to the robot training system 102 of FIG. 2.

At block 1002, the robot training system 102 is configured to monitor a welding operation. For example, a weld operator may position the robot training system 102 adjacent the robotic welding system 100, configure the workpiece and/or other parameters of a training operation, and/or otherwise configure the welding operation to reflect the weld to be performed by the robotic welding procedure.

At block 1004, the processor 20 determines a reference frame. For example, the processor 20 may receive image information from the sensor(s) 118, and identify one or more markers (e.g., the markers 302, 306, 308, 402 of FIGS. 3 and/or 4) from the table 104, the base 130, the workpiece 114, the welding tool 304, and/or any other equipment or fixture. Based on the identified markers, the processor 20 determines a reference frame, such as by determining and storing an origin or reference location, determining directional information (e.g., X, Y, and Z directions), and/or generating transformational models.

At block 1006, the processor 20 determines whether a welding operation (e.g., a robotic training procedure) has started. For example, the processor 20 may determine whether a trigger on the welding tool 304 has been pulled, whether welding current is flowing, and/or any other method of determining that a welding operation is occurring. The welding operation may be a live arc operation or a simulated operation (e.g., virtual, augmented reality, mediated reality, and/or any other type of weld simulation). To this end, the example welding tool 304 may be a live welding torch, a simulated welding torch, and/or any other tool that may be tracked by the robot training system 102. If a welding operation has not started (block 1006), control returns to block 1006 to await the welding operation and/or further configuration.

If a welding operation has started (block 1006), at block 1008 the sensors 118 and the processor 20 track a physical position and orientation of a welding tool (e.g., the welding tool 304) within the reference frame. For example, the processor 20 may receive physical position and orientation information from the sensor(s) 118, and/or determine the physical position and orientation information from raw and/or processed image data obtained from the sensor(s) 118. The processor 20 may store the position and orientation information in the memory 22 or storage device 24 to track the position and orientation information over the course of the welding operation.

In some examples, tracking may further involve monitoring position and/or orientation information for marker(s) on other objects. For example, the weld operator may attach markers (e.g., temporary markers) to objects such as the fixtures 116, portions of the workpiece 114, a clamp, and/or any other objects. The markers could, for example, indicate the presence of objects that may need to be avoided by the robotic manipulator 106 while executing the resulting robotic welding procedure, weld starting points, weld ending points, changes in weld parameters, and/or any other indications.

At block 1010, the processor 20 monitors the electrical parameters of the welding operation. For example, the processor 20 may receive measurements of the electrical parameters, such as weld current, weld voltage, and the like, from the power supply 110 and/or from sensors 118.

At block 1012, the processor 20 stores the physical position, orientation, and electrical parameters of the welding operation. In some examples, the processor 20 may receive or determine position and/or orientation information (e.g., samples) at different rates than the processor 20 receives electrical parameter information (e.g., samples). The processor 20 may store the information in the memory 22, the storage device 24, and/or at a remote location via a communication device.

At block 1014, the processor 20 determines whether the welding operation has ended. For example, the processor 20 may determine whether the trigger on the welding tool 304 is still being pulled, whether welding current is flowing, and/or any other method of determining that the welding operation is ongoing. If the welding operation has not ended (block 1014), control returns to block 1008 to continue monitoring the welding operation.

If the welding operation has ended (block 1014), at block 1016 the processor 20 filters the position, orientation, and electrical parameter information. For example, the processor 20 may smooth the position and/or orientation information, perform error correction of position and/or orientation information, filter short circuit events from the weld voltage, and/or any other filtering of undesired steady-state and/or transient events or conditions.

At block 1018, the processor 20 generates a robotic welding procedure based on the filtered positions, orientations, and electrical parameters by determining parameter setpoint(s) and physical robot positions, orientations, and/or movements. For example, the processor 20 may determine, from the position and orientation information, the joint positions and/or angles to be implemented by the robotic manipulator 106 to orient and position the torch 108. The robotic welding procedure may include commands to be sent to the power supply 110 by the robotic welding system 100 performing the robotic welding procedure, such as voltage commands, current commands, wire feed speed commands, pulse parameters, trigger commands, and/or any other command information. Additionally or alternatively, the robotic welding procedure may include requests for data and/or confirmation of parameters to be performed by the robotic welding system 100 prior to, during, and/or after the robotic welding operation.

In some examples, the processor 20 may determine the joint positions based on a predetermined structure of the workpiece 114, such as by detecting workpiece-related obstacles to the robotic manipulator 106. While a human welding operator may be able to naturally avoid such obstacles during the welding operation and position the welding torch accordingly, a naïve mimicry of the position and orientation information may result in collisions between the robotic manipulator 106 and/or the welding torch 108 with obstacles in the welding environment. For example, the processor(s) 20 may determine joint positions and/or travel paths to avoid obstacles identified by markers. The processor(s) 20 may determine the physical position and/or orientation of fixtures 116 having attached or affixed markers identified by the sensor(s) 118. The processor(s) 20 then generate the robotic welding procedure to avoid motions and/or positions calculated to cause a collision (or risk of collision) with the object(s) identified by the markers.

In some examples, the processor 20 may present a simulation of the robotic manipulator 106 performing the generated robotic welding procedure on the workpiece 114 for approval by the welding operator and/or engineer. For example, the processor 20 may render images of the robotic manipulator 106, the welding torch 108, the arc, the workpiece 114, the welding table 104, and/or any other elements captured and/or considered by the robot training system 102 and/or factored into generating the robotic welding procedure.

In some examples, blocks 1006-1016 may be performed multiple times, sequentially, for multiple welds on a same workpiece 114. For example, the robot training system 102 may track the position, orientation, and electrical parameter information for multiple passes on a same weld seam, for multiple weld seams, for multiple welds occurring on a same part, for including tacking welds, and/or for any other multiple-weld situation that can be performed by the robotic welding system 100. In such an example, at block 1018, generation of the robotic welding procedure may distinguish the different weld beads laid during the different welding operations performed sequentially, and generate the robotic welding procedure to perform the sequence of welds in the same order.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power source with a program or other code that, when being loaded and executed, controls the welding power source such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine readable storage media and to exclude propagating signals.

An example control circuit implementation may be a microcontroller, a field programmable logic circuit and/or any other control or logic circuit capable of executing instructions that executes weld control software. The control circuit could also be implemented in analog circuits and/or a combination of digital and analog circuitry.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A robotic welding system, comprising:
one or more sensors configured to determine a physical position and orientation of a welding tool with respect to a reference frame; and
a processor configured to:
communicatively connect to a welding-type power supply;
during a welding operation performed using the welding tool:
track the physical position and orientation of the welding tool within the reference frame; and
monitor at least one of an input or an output of the welding-type power supply; and
generate a robotic welding procedure based on the tracked physical position and orientation of the welding tool and based on the at least one monitored input or monitored output of the welding-type power supply.

2. The robotic welding system as defined in claim 1, further comprising a collaborative robot configured to perform the robotic welding procedure.

3. The robotic welding system as defined in claim 2, further comprising a welding table, wherein the collaborative robot is configured to perform welding on a workpiece on the welding table, wherein the processor is configured to calibrate the reference frame with respect to the welding table.

4. The robotic welding system as defined in claim 2, wherein the collaborative robot comprises a base configured to secure the collaborative robot to a support structure, wherein the processor is configured to calibrate the reference frame with respect to the base.

5. The robotic welding system as defined in claim 4, wherein the base comprises a first plurality of markers observable by at least one of the one or more sensors, wherein the processor is configured to calibrate the reference frame based on the markers.

6. The robotic welding system as defined in claim 5, wherein the welding tool comprises a second plurality of markers observable by at least one of the one or more sensors, and the processor is configured to determine the physical position and orientation of the welding tool based on the second plurality of markers.

7. The robotic welding system as defined in claim 6, wherein the welding tool comprises a third plurality of markers that are visually distinguishable from the second plurality of markers and observable by at least one of the one or more sensors, and the processor is configured to determine the physical position and orientation of the welding tool based on the third plurality of markers.

8. The robotic welding system as defined in claim 1, wherein the one or more sensors are configured to determine a physical position and orientation of an obstacle, and the processor is configured to generate the robotic welding procedure to avoid at least one of a motion or a position calculated to cause a collision based on the obstacle.

9. The robotic welding system as defined in claim 1, wherein the processor is configured to generate the robotic welding procedure by filtering at least one of the physical position or orientation of the welding tool.

10. The robotic welding system as defined in claim 1, further comprising a fixture configured to hold a workpiece associated with the robotic welding procedure in a same location during the robotic welding procedure as during the welding operation.

11. The robotic welding system as defined in claim 1, wherein the processor is configured to track the physical position and orientation of the welding tool by tracking one or more of a travel angle, a work angle, a contact-tip-to-work distance, a travel speed, or an aim.

12. The robotic welding system as defined in claim 1, wherein the processor is configured to monitor the input or output of the welding-type power supply by monitoring one or more of: a trigger command, a gas purge command, a jog command, a schedule parameter, a wire speed parameter, a voltage parameter, an arc length parameter, a current parameter, an electrode type parameter, an electrode diameter parameter, a gas type parameter, a material thickness parameter, a process parameter, a pulses per second parameter, an alternating current (AC) control parameter, or an arc control parameter.

13. The robotic welding system as defined in claim 1, wherein the processor is configured to monitor the input or output of the welding-type power supply by monitoring one or more of: an output indicator, a current detection indicator, a touch detection indicator, a gas on indicator, a ready indicator, an error indicator, a voltage feedback variable, a current feedback variable, a wire feed speed setpoint variable, a voltage setpoint variable, a current setpoint variable, or an arc length setpoint variable.

14. The robotic welding system as defined in claim 1, wherein the processor is configured to generate the robotic welding procedure by generating commands for joints of a robot.

15. The robotic welding system as defined in claim 1, wherein the processor is configured to generate the robotic welding procedure by generating at least one of a welding trigger command or a commanded welding-type parameter.

16. A method to train a robotic welding system, the method comprising:
configuring, using one or more sensors, a reference frame based on a predetermined component of a robotic welding system;
determining, using the one or more sensors, a physical position and orientation of a welding tool with respect to the reference frame;
tracking, using the one or more sensors and a processor, the physical position and orientation of the welding tool within the reference frame during a welding operation performed using the welding tool;
monitoring, using the processor, at least one of an input or an output of the welding-type power supply; and
generating, using the processor, a robotic welding procedure based on the tracked physical position and orientation of the welding tool.

17. The method as defined in claim 16, wherein the generating of the robotic welding procedure comprises generating commands for joints of a robot.

18. The method as defined in claim 16, wherein the generating of the robotic welding procedure comprises generating at least one of a welding trigger command or a commanded welding-type parameter.

19. The method as defined in claim 16, wherein the configuring of the reference frame is based on at least one component associated with a collaborative robot configured to perform the robotic welding procedure.

20. The method as defined in claim 16, further comprising positioning the one or more sensors adjacent the robotic welding system and moving the one or more sensors away from the robotic welding system following the welding operation.

21. The method as defined in claim 16, further comprising:
determining, using the one or more sensors, a physical position and orientation of an obstacle; and
generating, using the processor, the robotic welding procedure to avoid at least one of a motion or a position calculated to cause a collision based on the obstacle.
